(19) United States
(12) Patent Application Publication
(10) Pub. No.: US 2018/0255235 A1
(43) Pub. Date: Sep. 6, 2018

(54) IMAGE PROCESSING DEVICE AND PROGRAM

(71) Applicant: SHARP KABUSHIKI KAISHA, Sakai City, Osaka (JP)

(72) Inventor: NAO TOKUI, Sakai City (JP)

(21) Appl. No.: 15/754,121

(22) PCT Filed: Aug. 26, 2016
(86) PCT No.: PCT/JP2016/074901

§ 371 Date: Feb. 21, 2018

(30) Foreign Application Priority Data
Aug. 26, 2015 (JP) 2015-166908

(51) Int. Cl. H04N 5/232; G06T 5/00

(52) U.S. Cl. CPC H04N 5/23219; H04N 5/23293; G06T 5/002; H04N 5/23235

(57) ABSTRACT

To prevent an appearance of a subject included in an image after its size changing from being spoiled. A face refinement processing unit (24) processes a skin area of the subject included in at least a part of the image after its size changing by face refinement processing to a degree depending on a size change ratio.

### TECHNICAL FIELD

An aspect of the present invention relates to image processing technology, particularly, to an image processing device and a program which performs proper face refinement processing on an image.

### BACKGROUND ART

In recent years, a technology has been developed in which a preferable image is generated by processing a magnified image by prescribed image processing. For example, PTL 1 discloses a video signal processing apparatus which adjusts a contour correction gain in a camera signal means in accordance with a magnification ratio of an image in order to obtain an image whose contour portion is kept sharp even in a case that the image is magnified by electronic zooming.

### CITATION LIST

### Patent Literature

PTL 1: JP 2005-20061 A (published on Jan. 20, 2005)

### SUMMARY OF INVENTION

### Technical Problem

However, in the technology disclosed in PTL 1, due to correction to keep contour portions of the image sharp by increasing a contour correction gain in a case of magnification of an image, a skin discoloration and wrinkles appearing on a face of a subject are emphasized. This causes a problem of spoiling an appearance of the subject included in the image after its size changing.

An aspect of the present invention has been made in order to solve the above problem. An object of the present invention is to provide an image processing device and a program, capable of preventing an appearance of a subject included an image after its size changing from being spoiled.

### Solution to Problem

An image processing device according to an aspect of the present invention, in order to solve the above problems, includes a size change ratio calculation unit configured to calculate a size change ratio of an image including a subject, an image size change unit configured to change a size of at least a part of the image, based on the size change ratio, a skin area extraction unit configured to extract a skin area of the subject included in the at least a part of the image after changing the size of the image, and a face refinement processing unit configured to process the skin area by face refinement processing to a degree depending on the size change ratio.

### Advantageous Effects of Invention

According to an aspect of the present invention, an effect is exerted that an appearance of a subject included in an image after its size changing can be prevented from being spoiled.

### BRIEF DESCRIPTION OF DRAWINGS

FIG. 1 is a functional block diagram illustrating a constitution of an image display device including an image processing device according to Embodiment 1 of the present invention.

FIGS. 2A to 2C are diagrams describing change of an image size in Embodiment 1 of the present invention.

FIGS. 3A and 3B are diagrams describing extraction of a skin area in Embodiment 1 of the present invention.

FIG. 4 is a diagram illustrating a relationship between a size change ratio and a degree of face refinement processing in Embodiment 1 of the present invention.

FIGS. 5A and 5B are diagrams for describing shade superposition processing in Embodiment 1 of the present embodiment.

FIG. 6 is a flowchart illustrating a flow of an image processing method performed by the image processing device according to Embodiment 1 of the present invention.

FIG. 7 is a functional block diagram illustrating a constitution of an image display device including an image processing device according to Embodiment 2 of the present invention.

FIG. 8 is diagram describing details of face detection in Embodiment 2 of the present invention.

FIG. 9 is a diagram illustrating a relationship between a size change ratio and a degree of face refinement processing in Embodiment 2 of the present invention.

FIG. 10 is a flowchart illustrating a flow of an image processing method performed by the image display device according to Embodiment 2 of the present invention.

### DESCRIPTION OF EMBODIMENTS

A description is given in detail below of embodiments according to the present invention with reference to the accompanying drawings. The accompanying drawings merely illustrate specific embodiments complying with a principle of the present invention. These drawings are provided only for understanding the present invention and not for construing the present invention in a limited manner. Note that elements illustrated in the accompanying drawings are intentionally illustrated to be exaggerated for deeply understanding the present invention, and are different from actual elements in distances therebetween and sizes thereof.

In the following descriptions, in a case that a reference sign assigned to a certain element in a drawing is also assigned to the same element in another drawing, a constitution, function and the like of the same element is the same as the certain element, and thus, a detailed description of the same element is omitted. Moreover, an “image” or “content data” described below refer to those including both a still image and a moving image. Further, in a case that a moving image includes sound information, an “image” and “content data” also include the sound information.

### Embodiment 1

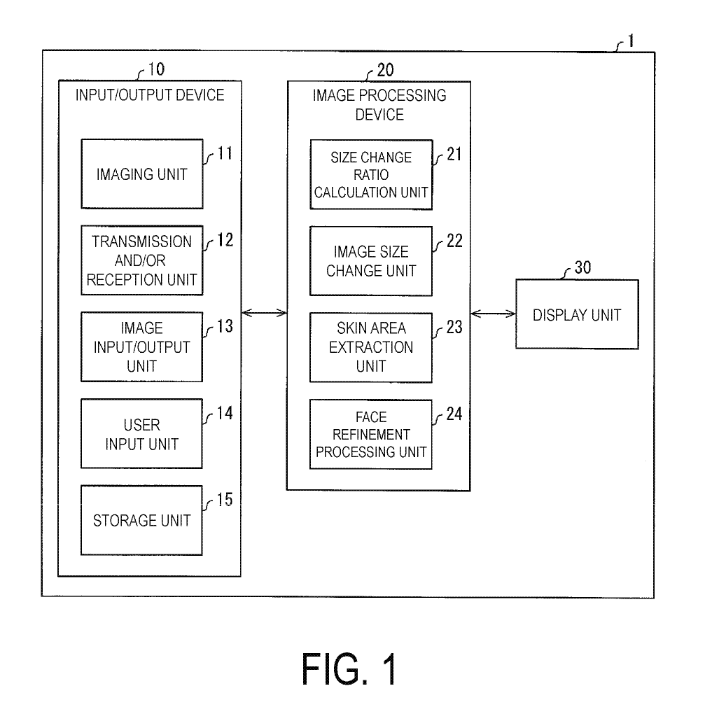

Embodiment 1 according to the present invention is described below based on FIG. 1 to FIG. 6.

### Device Constitution

FIG. 1 is a functional block diagram illustrating a constitution of an image display device 1 including an image processing device 20 according to Embodiment 1 of the present invention. As illustrated in FIG. 1, the image display device 1 includes an input/output device 10, the image processing device 20, and a display unit 30. The input/output device 10 includes an imaging unit 11, a transmission and/or reception unit 12, an image input/output unit 13, a user input unit 14, and a storage unit 15. The image processing device 20 includes a size change ratio calculation unit 21, an image size change unit 22, a skin area extraction unit 23, and a face refinement processing unit 24.

The image display device 1 is achieved as various devices capable of displaying an image. Specific examples of the image display device 1 include a television set, a monitor, a cellular phone, a smartphone, a tablet PC, a PC, a portable game console, an electronic photo frame, a digital still camera, and a video camera, for example.

### Imaging Unit 11

The imaging unit 11 includes an imaging lens and an imaging element such as a Charge Coupled Device (CCD), and images a subject to generate an image (still image or moving image) including the subject.

Transmission and/or Reception Unit 12

The transmission and/or reception unit 12 is a commonly used interface for receiving and transmitting content data and the like. The transmission and/or reception unit 12 receives an image provided by way of a TV broadcast wave, the Internet, and other communication lines. The transmission and/or reception unit 12 may be a component which receives and reproduce the content data included in a broadcast wave, the content data being provided by the television set receiving the broadcast wave of television broadcasting or the like. Alternatively, the transmission and/or reception unit 12 may be a component which receives and reproduces the content data delivered from the Internet or other communication lines.

Image Input/Output unit 13

The image input/output unit 13 is a commonly used component which accepts an image input from outside of the input/output device 10 to output as an input image. The image input/output unit 13 may be any component so long as the component receives the content data. For example, the image input/output unit 13 may be a component which includes a receiver or the like accepting an image signal from external equipment such as a disc player (or disk player) and uses the receiver or the like to accept and reproduce the content data.

### User Input Unit 14

The user input unit 14 is a component which receives an instruction to the image display device 1 from a user (instruction of change of an image size or the like) and outputs the instruction to the image processing device 20. The user input unit 14 can use, for example, an input device such as a keybutton, a touch panel, a mouse, or a microphone, an infrared irradiation device detecting a motion of a human body, or the like to receive an instruction or voice command from the user.

### Storage Unit 15

The storage unit 15 is a commonly used component which can store an image or content data in a recording medium, or read an image or content data stored in the recording medium to output to the image processing device 20. The storage unit 15 may be a component which reads content data from a prescribed recording medium and reproduces the read content data, for example. Examples of the recording medium include a storage device within a commercially available camera (a digital still camera, a video camera, etc.,), or a detachable storage device (an electronic medium such as a magnetic optical disk and a semiconductor memory).

The imaging unit 11, transmission and/or reception unit 12, image input/output unit 13, and storage unit 15 constituting the input/output device 10 are the components used to provide an image to the image processing device 20 by different methods. The input/output device 10 may be configured to include at least one of these units. A description is given below of an example that the input/output device 10 includes the imaging unit 11, the storage unit 15, and the user input unit 14. Specifically, the present embodiment describes an example of a case that the image display device 1 images a subject by using the imaging unit 11, generates, from the imaged image, an image processed by proper face refinement processing depending on a size change ratio of the subject, and displays the generated image on the display unit 30.

### Display Unit 30

The display unit 30 is constituted by a commonly used Liquid Crystal Display (LCD) or the like and displays an image, text data and the like input from outside.

The input/output device 10 and the display unit 30 are commonly used equipment, and do not directly relate to features of the present invention. Therefore, a detailed description of the input/output device 10 and the display unit 30 will be omitted.

### Image Processing Device 20

The image processing device 20 processes the image acquired from the input/output device 10, based on the user instruction acquired from the user input unit 14, and outputs the processed image to at least one of the display unit 30 and the input/output device 10. The image processing device 20 may be constituted as a Central Processing Unit (CPU), a Graphic Processing Unit (GPU, a processing device for image processing), or the like, for example.

### Size Change Ratio Calculation Unit 21

The size change ratio calculation unit 21 calculates, based on a size change instruction on the image, input from the user input unit 14, a change ratio (size change ratio) for the image size change unit 22 to change a size of the image. Details of this processing are described later.

### Image Size Change Unit 22

The image size change unit 22 changes a size of at least a part of the image (that is, all or a part of the image) acquired by the image processing device 20 from the input/output device 10, based on the calculated size change ratio. Details of this processing are described later.

### Image Size Change Unit 22

The skin area extraction unit 23 extracts from the image a skin area of the subject included in the image. Details of this processing are described later.

Face Refinement Processing unit 24

The face refinement processing unit 24 processes the skin area of the subject in the image by the face refinement processing to a degree depending on the calculated size change ratio. Details of this processing are described later.

### Details of Size Change Ratio Calculation

The size change ratio calculation unit 21 calculates, based on the size change instruction on the image, input from the user input unit 14, the size change ratio of the image. The size change ratio is a value representing a ratio of the number of vertical pixels of an image as a reference to the number of vertical pixels of the pixels after size changing, or a ratio of the number of horizontal pixels of an image as a reference to the number of horizontal pixels of the pixels after size changing, in changing (magnifying or reducing) the size of all or a part of the image. In a case that the size change ratio is 1, the size of the image is not changed. In other words, the number of vertical pixels of the image of which size is changed based on this size change ratio is equal to the number of vertical pixels of the image as a reference. On the other hand, the image is magnified in a case that the size change ratio is larger than 1, whereas the image is reduced in a case that the size change ratio is smaller than 1.

In a case that a size of a part of the image is changed, the number of vertical pixels and the number of horizontal pixels of a range in the image of which size is changed may be used as the number of vertical pixels and the number of horizontal pixels of the image as a reference.

There are various methods for inputting the size change instruction to the image display device 1 by the user. For example, the user can input the size change instruction by inputting the size change ratio as a numerical value via a software keyboard displayed on the display unit 30. As other method, the user can perform a prescribed pinch-in operation or pinch-out operation on a touch panel not illustrated which is included in the display unit 30 or a remote control device not illustrated to input the size change instruction. Alternatively, a scheme may he used in which the user presents a prescribed motion (gesture) expressing the size change instruction to the image display device 1 using both his/her hands and the image display device 1 recognizes this motion.

Inputting the size change instruction via the remote control device allows the user to input the size change ratio as a numerical value such as 1.2 and 0.2. At this time, it is preferable to display a frame as a size change range of the image depending on the input numerical value, and this allows the user to easily specify the size change ratio.

In inputting the size change instruction to the touch panel, the user first touches a screen of the display unit 30 by his/her finger and thumb, and then, moves the finger and thumb close to each other in such a manner as to pinch the screen (pinch-in) or moves the finger and thumb away from each other in such a manner as to flick the screen (pinch-out). The image display device 1 can configure the size change ratio to 1 or less in the former case, and can configure the size change ratio to 1 or more in the latter case. In such a case, the image display device 1 calculates a value of the size change ratio from a ratio based on touch start points and touch end points of the finger and thumb.

In inputting the size change instruction by presenting the gesture, the user moves his/her left and right hands. The image display device 1 configures the size change ratio to 1 or less in a case that a gesture of putting the left hand and the right hand closer to each other is presented, and configures the size change ratio to 1 or greater in a case that a gesture of pulling the left hand and right hand away from each other is presented. The image display device 1 can calculate a value of the size change ratio from a ratio based on gesture start points of the left and right hands and gesture end points of the left and right hands.

### Details of Image Size Change

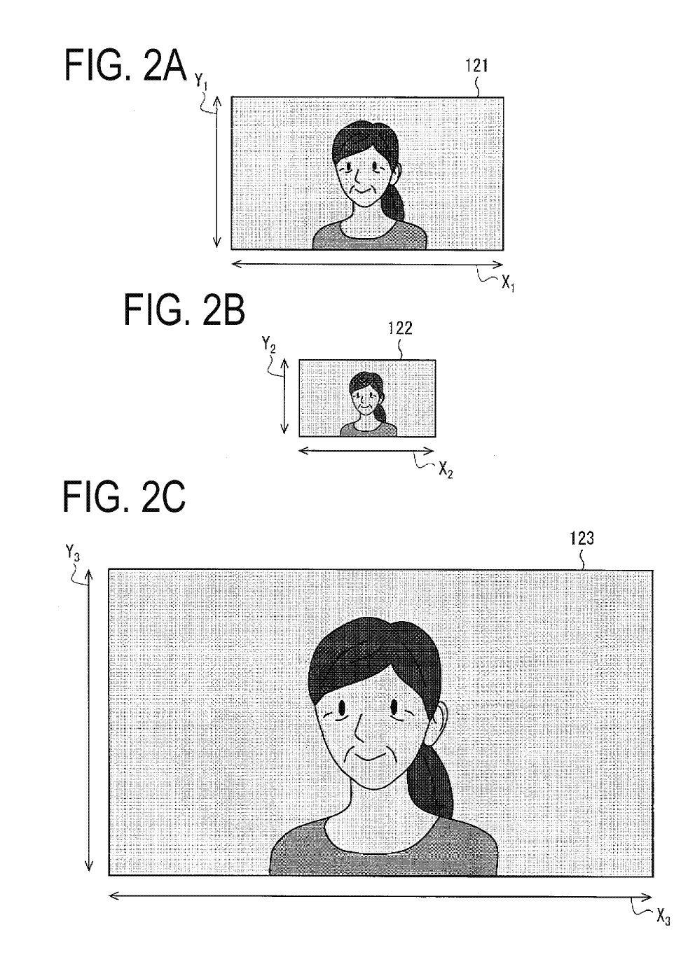

FIGS. 2A to 2C are diagrams describing change of the image size in Embodiment 1 of the present invention. The image size change unit 22 changes (magnifies or reduces) the size of all or a part of the image acquired by the image processing device 20 from the input/output device 10, based on the calculated size change ratio. FIG. 2A, an image 121 before its size changing is illustrated. The number of horizontal pixels X₁ of the image 121 is 1920 pixels and the number of vertical pixels Y₁ is 1080 pixels.

In a case that the size change ratio is 0.5, the image size change unit 22 converts the image 121 into an image 122 illustrated in FIG. 2B. The number of horizontal pixels X₂ of the image 122 is 960 pixels, and the number of vertical pixels Y₂ is 540 pixels. To be more specific, the image size change unit 22 reduces the size of the image 121 to one fourth to generate the image 122 after reduction.

On the other hand, in a case that the size change ratio is 2, the image size change unit 22 converts the image 121 into an image 123 illustrated in FIG. 2C. The number of horizontal pixels X₃ of the image 123 is 3840 pixels, and the number of vertical pixels Y₃ is 2160 pixels. To be more specific, the image size change unit 22 magnifies the size of the image 121 four times to generate the image 123 after magnification.

As described above, the image processing device 20 generates a new image magnified or reduced from an original image, based on the input size change ratio.

### Details of Skin Area Extraction

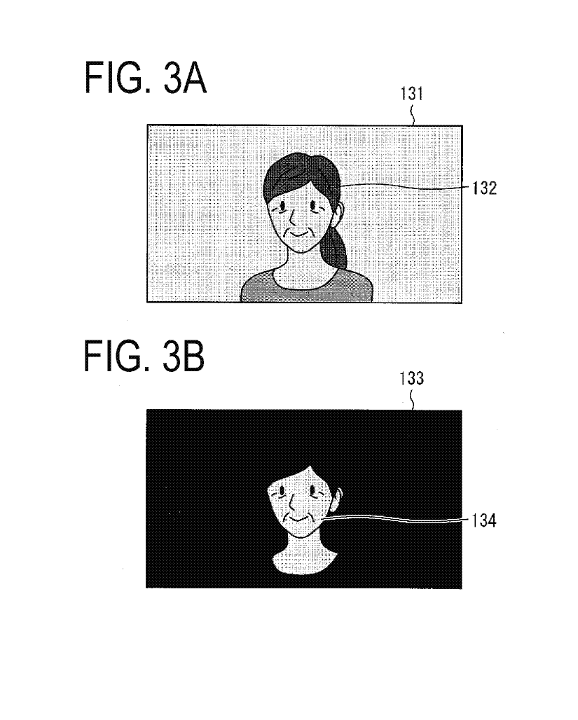

FIGS. 3A and 3B are diagrams describing extraction of the skin area in Embodiment 1 of the present invention. In FIG. 3A, an image 131 input to the image processing device 20 is illustrated. The image 131 includes a subject 132 expressing a person (woman). The skin area extraction unit 23 extracts a skin area of the subject 132 from a whole area in the image 131 using Equation (1) below.

[Equation 1]

D=\sqrt{(Rᵢ−Rₛ)²+(Gᵢ−Gₛ)²+(Bᵢ−B_{y})²} (1)

In Equation (1), each of Rᵢ, Gᵢ, and Bᵢ represents a value of a primary color (red, green, or blue) specifying a color of each of pixels included in the image 131. An index i represents a number indicating any pixel in the image, and takes a value of 1 or greater. Each of Rₛ, Gₛ, and Bₛ represents a value of the primary color (red, green, or blue) specifying a skin color as a reference. As expressed in Equation (1), the skin area extraction unit 23 calculates a distance D between the values of the primary colors specifying each of the pixels in the image 131 and the values of the primary colors specifying the skin color as a reference. An area including pixels having the calculated distance D of a specific threshold TH or less is extracted as the skin area of the subject 132. The skin area extraction unit 23 outputs, as a skin area extraction result, an image 134 in which only a skin area 134 extracted from the image 131 is masked to the face refinement processing unit 24 as illustrated in FIG. 3B.

As the skin color as a reference, an ideal skin color, a color obtained by averaging colors of skin areas of multiple persons, or the like may be used. Further, in a case that multiple different skin colors each of which is used as a reference are configured, and the skin color as a reference used for the skin area extraction is switched depending on an imaging condition of the input image, various imaging conditions can be met, so this is preferable. In calculating the distance D, weighting may be performed for each of an R value, a G value, and a B value. Further, in calculating the distance D, an equivalent result can be also obtained even in a case that color values depending on a different color space such as a hue value, a saturation value, and a brightness value are used rather than the R value, the G value, and the B value. In the above example, the distance between the color of the pixel and the skin color as a reference is calculated for each pixel of interest (one pixel), but in a case that used are an average value and intermediate value of the colors in a local area constituted by the pixel of interest and surrounding pixels thereof instead of only using the pixel of interest, an influence of a noise in the image can be suppressed, so this is preferable.

### Details of Face Refinement Processing

The face refinement processing unit 24 processes the skin area of the subject by the face refinement processing to a degree depending on the input size change ratio. In other words, a degree of the face refinement processing is changed depending on the size change ratio. The face refinement processing referred to here includes smoothing processing, skin color correction processing, or shade superposition processing on the skin area. The face refinement processing unit 24 processes the skin area by at least one of these processing.

Changing a degree of the face refinement processing means at least one of the followings, for example.

1. A degree of the smoothing processing is changed to change weighting on removal of pores of skin, skin discoloration, wrinkles and the like in the skin area.

2. A degree of the skin color correction processing is changed to change a degree of whitening or making into a health skin the skin area.

3. A degree of the shade superposition processing is changed to change an emphasizing degree of a stereoscopic effect on a face including the skin area.

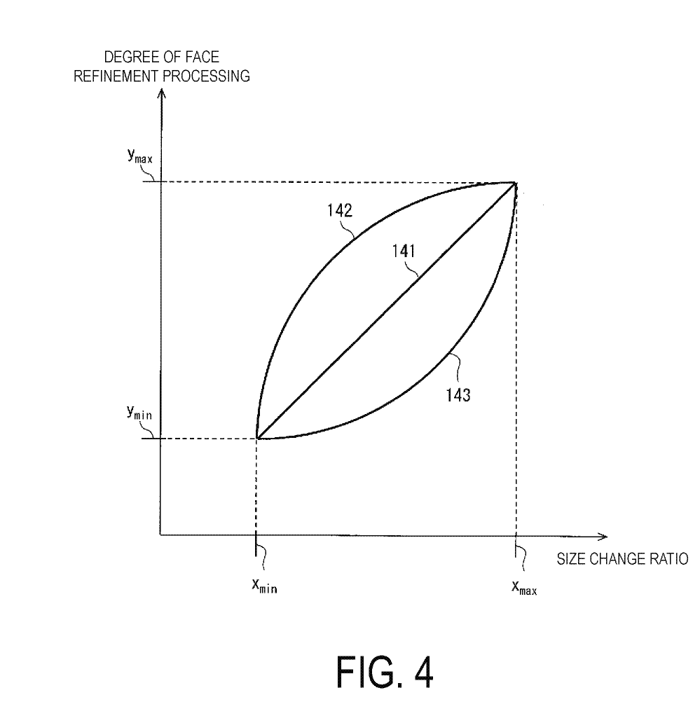

FIG. 4 is a diagram illustrating a relationship between the size change ratio and the degree of face refinement processing in Embodiment 1 of the present invention. In FIG. 4, a horizontal axis represents the size change ratio, and a vertical axis represents the degree of the face refinement processing. In a case that the size change ratio is a minimum value X_{13 min}, the degree of the face refinement processing is also a minimum value Yₘᵢₙ. On the other hand, in a case that the size change ratio is a maximum value Xₘₐₓ, the degree of the face refinement processing is also a maximum value Yₘₐₓ. The face refinement processing unit 24 uses any of a straight line 141, a curved line 142, or a curved line 143 illustrated in FIG. 4 to change the degree of the face refinement processing depending on the size change ratio in such a way that the higher the size change ratio, the higher the degree of the face refinement processing. Specifically, the face refinement processing unit 24 configures a relationship between the size change ratio and the degree of the face refinement processing to be represented by any of the linear straight line 141, the non-linear curved line 142, or the non-linear curved line 143.

For example, in a case that a resolution of the input image is equal to a resolution of a display area in the display unit 30, the face refinement processing unit 24 configures the relationship between the size change ratio and the degree of the face refinement processing to be represented by the straight line 141. This maintains constant a ratio of a change amount of the degree of the face refinement processing to a change amount of the size change ratio of the image regardless of the value of the size change ratio. As a result, in a case that the image including the subject whose skin discoloration, wrinkles and the like are likely to be conspicuous is magnified to be displayed, the degree of the face refinement processing can be properly heightened depending on the size change ratio. On the other hand, in a case that the image including the subject whose skin discoloration, wrinkles and the like are less likely to be conspicuous is reduced to be displayed, the degree of the face refinement processing can be properly lowered depending on the size change ratio.

For example, in a case that a resolution of the input image is larger than a resolution of the display area in the display unit 30, the face refinement processing unit 24 configures the relationship between the size change ratio and the degree of the face refinement processing to be represented by the curved line 142. In this case, the image display device 1 may configure the size change ratio in a case that the input image is reduced in such a way that the display area accommodates the input image for the minimum value Yₘᵢₙ of the size change ratio. In this case, a size change ratio for cutting out and displaying a part of the input image is larger than the minimum value Yₘᵢₙ. At this time, even in a case that the calculated size change ratio is close to the minimum value Yₘᵢₙ, the resolution of the displayed image is sufficiently high, and thus, the face of the subject is displayed bigger, so the skin discoloration and the wrinkles may be conspicuous. For this reason, the curved line 142 (curved line protruding upward) is used which is larger in the degree of the face refinement processing relative to the size change ratio as compared with the straight line 141 such that the degree of the face refinement processing is changed into a larger value. This can appropriately remove the pores of skin, skin discoloration, wrinkle, and the like of the subject, so this is preferable.

For example, in a case that a resolution of the input image is smaller than a resolution of the display area in the display unit 30, the face refinement processing unit 24 configures the relationship between the size change ratio and the degree of the face refinement processing to be represented by the curved line 143. In this case, the image display device 1 may configure the size change ratio in a case that the input image is magnified in such a way that the display area accommodates the input image for the maximum value Yₘₐₓ of the size change ratio. At this time, even in a state that the calculated size change ratio is close to the maximum value Yₘₐₓ, the skin discoloration, wrinkles, and the like of the subject are inconspicuous because the resolution of the displayed image is low, so the degree of the face refinement processing is configured to be relatively low. In a case that the size change ratio is smaller than a maximum value 405, the curved line 143 (curved line protruding downward) is used which is smaller in the degree of the face refinement processing corresponding to the same size change ratio as compared with the straight line 141 such that features of the face of the subject are kept while the pores of skin, skin discoloration, wrinkles, and the like of the subject can be properly removed, so this is preferable.

### Smoothing Processing

The smoothing processing means processing that the pores of skin, skin discoloration, wrinkles, and the like appearing on the skin area of the subject are defocused to be removed, or made inconspicuous. The face refinement processing unit 24 processes the skin area of the subject included in the image after its size changing by these processing. The skin area extraction unit 23 extracts the skin area of the subject included in the image after its size changing, based on the skin area extracted from the input image and the calculated size change ratio. For example, in a case that a pixel (ki, kj) in the input image corresponding to any pixel (i, j) in the image after its size changing is a pixel within the skin area, the point (i, j) is specified as a pixel constituting the skin area. The face refinement processing unit 24 extracts a prescribed area including specified pixels as the skin area within the image after its size changing.

The image size change unit 22 may magnify or reduce at the specified size change ratio the skin area extracted from the input image by the skin area extraction unit 23 such that the skin area is extracted from the image after its size changing. In this case also, the skin area after its size changing can be extracted similarly.

The face refinement processing unit 24 uses Equation (2) below to process the skin area by the smoothing processing.

$$\begin{matrix}[ Equation 2 ] & \\ O ( i , j ) = \frac{1}{{N}^{2}} {\sum }_{k = - [ N / 2 ]}^{N / 2} {\sum }_{l = - [ N / 2 ]}^{N / 2} I ( i + k , j + l ) & ( 2 )\end{matrix}$$

In Equation (2), I(i+k, j+1) represents a pixel constituting an image before the smoothing processing, and O represents a pixel constituting an image after the smoothing processing. N represents a natural number. As expressed by Equation (2), in the smoothing processing, an average value of values of all pixels included in a local area constituted by N×N pixels is calculated as an output value of a pixel at the center of the local area.

In a case that a value of N is increased, the image can be strongly defocused, and in a case that the value of N is decreased, the image can be weakly defocused. In other words, the degree of the smoothing processing can be changed by changing the value of N. In a case that the degree of the smoothing processing is heightened (i.e., in a case that the value of N is increased), an effect is strengthened of defocusing the pores of skin, skin discoloration, wrinkles, and the like to be removed. On the other hand, in a case that the degree of the smoothing processing is lowered (i.e., in a case that the value of N is decreased), the features of the skin area in the original image can be kept as they are although the effect of removing the pores of skin and the like is weakened.

In the magnified image, the pores of skin and the like appearing in the skin area are conspicuous, and thus, the image is preferably strongly defocused to remove the pores of skin, skin discoloration, wrinkles, and the like. On the other hand, in the reduced image, the pores of skin and the like appearing in the skin area are not likely to be conspicuous, and thus, the effect of removing the pores of skin, skin discoloration, wrinkles, and the like is sufficiently obtained, and further, the effect of keeping the features of the original image as they are can also be obtained even in a case that the image is weakly defocused. At this time, even in a case that an area that is not actually the skin area (e.g., an eyebrow or the like) is erroneously extracted as the skin area in the skin area extraction processing, the eyebrow or the like is not defocused, so the image to be preferably displayed can be generated.

In the present embodiment, the smoothing processing is described as the processing using an averaging filter expressed by Equation (2), but other filters such as a Gaussian filter or a bilateral filter can be used instead of the averaging filter to obtain a similar effect.

Note that the skin area in the image after its size changing can be processed by the smoothing processing to obtain an image in which only the skin area is smoothed without defocusing a background, hair, and the like.

### Skin Color Correction Processing

The skin color correction processing means processing of correcting the color of the skin area into a preferable skin color. The face refinement processing unit 24 uses Equation (3) below to process the skin area by the skin color correction processing, for example.

[Equation 3]

Rₒ=α(Rₐ−Rᵢ)+Rᵢ

Gₒ=α(Gₐ−Gᵢ)+Gᵢ

Bₒ=α(Bₐ−Bᵢ)+Bᵢ (3)

In Equation (3), Rₐ, Gₐ, and Bₐ represent values of the respective primary colors specifying a target skin color. On the other hand, Rᵢ, Gᵢ, and Bᵢ represent values of the respective primary colors specifying a color of a pixel of interest within a skin area to be processed. A variable a is a coefficient representing a degree of mixture and takes any value in a range from 0 to 1. The face refinement processing unit 24 performs the skin color correction processing by mixing the target skin colors with the pixels of interest within the skin area as expressed by Equation (3). Note that, processing only the skin area in the image after its size changing by the skin color correction processing allows to obtain an image in which only the skin color is corrected without changing a background, hair, and the like.

In a case that the coefficient a is 0, the skin color correction processing is not performed, and thus, the skin color in the image after its size changing is a skin color in the output image without change. In a case that the coefficient a is 1, the target skin color is a skin color in the output image. In this way, the degree of the skin color correction processing can be changed by changing the value of the coefficient a. In a case that the degree of the skin color correction processing is further heightened (that is, in a case that the value of a is further increased), a color of the skin area in the image after its size changing is converted into a skin color closer to the target skin color. On the other hand, in a case that the degree of the skin color correction processing is further lowered (that is, in a case that the value of a is further decreased), the skin color of the skin area in the image after its size changing can be kept in a state closer to the original skin color.

For example, an effect of correcting a dullness, unevenness, and the like of the skin color can be more strengthened by further heightening the degree of the skin color correction processing for the magnified image. On the other hand, in the reduced image, the dullness, unevenness, and the like in the skin area are not likely to be conspicuous, and thus, the sufficient effect can be obtained even in a case that the degree of the skin color correction processing is lowered. Further, the degree of the skin color correction processing on only the skin area is lowered, and thus, a difference can be prevented from generating between a color tone of the skin area after the skin color correction processing and color tones of the background and hair, so the image to be more preferably displayed can be generated.

The above example describes the skin color correction processing in the case of specifying the color of the pixel by the RGB values representing the red color, the green color, and the blue color, but instead, the skin color correction processing in a case of specifying the color of the pixel by HSV values representing hue, saturation value, brightness, or the like can also be used.

### Shade Superposition Processing

The shade superposition processing means processing of superposing a shade on the skin area to emphasize the stereoscopic effect on the face. The face refinement processing unit 24 uses Equation (4) below to process the skin area by the shade superposition processing.

[Equation 4]

Rᵢ(i, j)=Rᵢ(i, j)(1−(1−S(i, j)))β)

Gₒ(i, j)=Gᵢ(i, j)(1−(1−S(i, j))β)

Bₒ(i, j)=B(i, j)(1−(1−S(i, j))β) (4)

In Equation (4), S represents a shade and takes any value in a range from 0 to 1. A variable β is a coefficient representing a degree of a shade and takes any value in a range from 0 to 1.

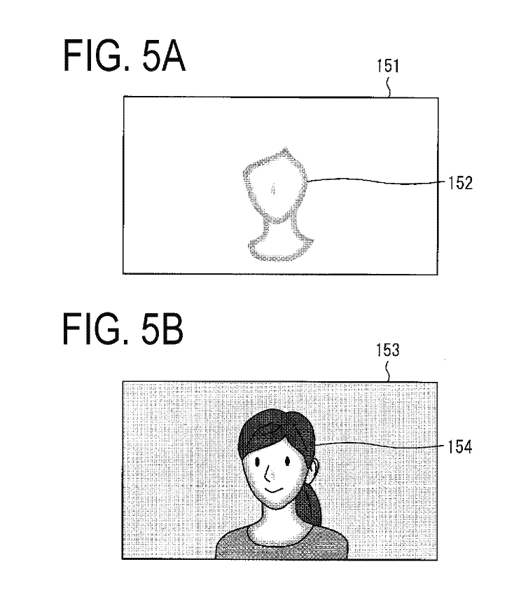

The face refinement processing unit 24 performs the shade superposition processing by superposing a prescribed shade S on the primary colors and Bᵢ constituting the pixels in the skin area as expressed by Equation (4). The smaller a value of the shade S, the stronger the shade, whereas the larger the value of the shade S, the weaker the shade. An example of the shade S is illustrated in FIGS. 5A and 5B. FIGS. 5A and 5B are diagrams for describing the shade superposition processing in Embodiment 1 of the present embodiment. FIG. 5A illustrates, as an example of the shade S, a shade 152 appearing on positions of a ridge of a nose and cheek of the subject included in a shade specifying image 151. The face refinement processing unit 24 can superpose the shade 152 on the skin area of the subject in the input image to generate an image 153 improved in the stereoscopic effect on the subject 154 such as that the ridge of the nose seems to be long and the cheek seems to be firm as illustrated in FIG. 5B.

The shade S is stored in advance as a template in the storage unit 15 or the like, The face refinement processing unit 24 can change a size of the template depending on a size of the skin area in the image after its size changing and arrange the template at the position of the skin area to superpose the shade S on the skin area. At this time, the face refinement processing unit 24 can process the skin area by labeling processing and calculate the total number of pixels of the skin area to estimate the size of the skin area. A position of a gravity center of the skin area may be used as the position of the skin area.

The coefficient β in Equation (4) takes any value in a range from 0 to 1. In a case that the coefficient β is 0, the shade superposition processing is not performed. Therefore, in the constitution that the shade superposition processing is only performed as the face refinement processing, in a case that p is 0, the skin area is not processed by the face refinement processing. Specifically, an image including, without change, the skin area in the image after its size changing is generated.

On the other hand, in a case that the coefficient β is larger than 0, the skin area is processed by the shade superposition processing. The closer to 1 the coefficient β, the stronger the shade superposed on the skin area. In this way, the degree of the shade superposition processing can be changed by changing the coefficient β. To be more specific, in a case that the coefficient β is further decreased (in a case that the degree of the shade superposition is further lowered), the shade superposed on the skin area is thinner, whereas in a case that the coefficient β is further increased (in a case that the degree of the shade superposition is further heightened), the shade superposed on the skin area is thicker.

For example, as for the magnified image, in a case that the coefficient β is further heightened, the stereoscopic effect on the face of the subject can be more emphasized. On the other hand, as for the reduced image, in a case that the coefficient β is further lowered, the stereoscopic effect to some degrees can be given on the face of the subject. In the latter case, inconsistency in a light source environment between a shade on the background and a shade superposed on the face can be made to be inconspicuous, so this is preferable.

The face refinement processing unit 24 may perform at least one face refinement processing of the smoothing processing, skin color correction processing, and shade superposition processing described above. In a case that the skin area is processed first by the smoothing processing, next by the skin color correction processing, and finally by the shade superposition processing, a preferable new shade can be superposed on the skin area after an original unnecessary shade in the skin area is removed, so this is preferable.

### General Processing Flow

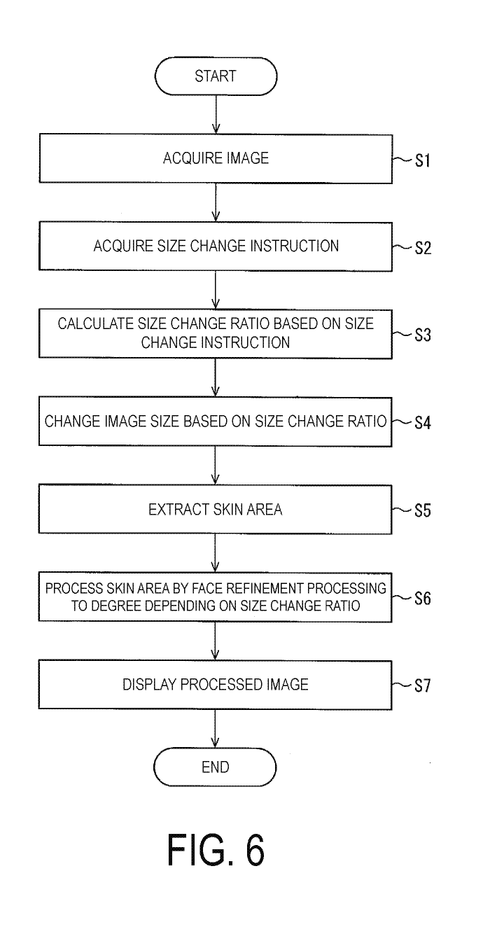

FIG. 6 is a flowchart illustrating a flow of an image processing method performed by the image processing device 20 according to Embodiment 1 of the present invention. As illustrated in FIG. 6, once the processing starts, the image processing device 20 first acquires an image to be displayed from any component in the input/output device 10 (the imaging unit 11, the transmission and/or reception unit 12, or the like) (S1). Next, the user input unit 14 acquires the size change instruction on the image, input by the user, and outputs the size change instruction to the image processing device 20 (S2).

Next, the size change ratio calculation unit 21 calculates the size change ratio of the image, based on the input size change instruction (S3, size change ratio calculation process). In a case that the user input unit 14 does not acquire the size change instruction at this time, the size change ratio calculation unit 21 may automatically calculate the size change ratio. For example, the size change ratio is automatically calculated in the case of magnifying the input image in such a way that the display area of the display unit 30 accommodates the input image.

Next, the image size change unit 22 changes the size of the input image depending on the calculated size change ratio (S4, image size change process). As a result, the image is magnified or reduced. Next, the skin area extraction unit 23 extracts the skin area in the subject included in the input image (S5, skin area extraction process). Next, the face refinement processing unit 24 processes the skin area by the face refinement processing to a degree depending on the size change ratio (S6, face refinement processing process). The face refinement processing unit 24 outputs the image after the face refinement processing to the display unit 30, and the display unit 30 displays the image input to the display unit 30 (S7). This ends the processing illustrated in FIG. 6.

According to the image display device 1 including the image processing device 20 according to Embodiment 1 of the present invention describe above, the appearance of the subject included in the image after its size changing can be prevented from being spoiled. In other words, even in a case that the size of the image is changed, the image preferable for the user can be generated.

### Supplementary Note

In the present embodiment, the image processed by the face refinement processing by the image processing device 20 included in the image display device 1 is displayed on the display unit 30 included in the same image processing device 20, but the present invention is not limited thereto. For example, the constitution may be employed such that an image processed by the face refinement processing by another image display device 1 including another image processing device 20 is received by the image processing device 20 via the transmission and/or reception unit 12 and displayed on the display unit 30. According to this constitution, the face refinement processing can be performed by another image display device 1 in a case of a teleconference and video chat with a remote location via the transmission and/or reception unit 12, so this is preferable.

In the present embodiment, the skin area extraction unit 23 extracts the skin area of the subject from the input image, but the present invention is not thereto. For example, the skin area extraction unit 23 may extract, from the image after its size is changed by the image size change unit 22 (magnified image or reduced image), the skin area of the subject (the skin area after magnification or the skin area after reduction). Particularly, in a case that the skin area is extracted from the reduced image, a processing amount required for the extraction can be reduced, so this is preferable.

In the present embodiment, the face refinement processing unit 24 processes the skin area in the image after its size changing by the face refinement processing, but the present invention is not limited thereto. For example, the face refinement processing unit 24 may store the image before the face refinement processing in advance, and replace or mix the skin area in the image before the face refinement processing with the skin area in the image after the face refinement processing to generate the image processed by the face refinement processing. Particularly, mixing the skin area before the face refinement processing with the skin area after the face refinement processing allows to easily generate the image changed to the degree of the face refinement processing, so this is preferable.

### Embodiment 2

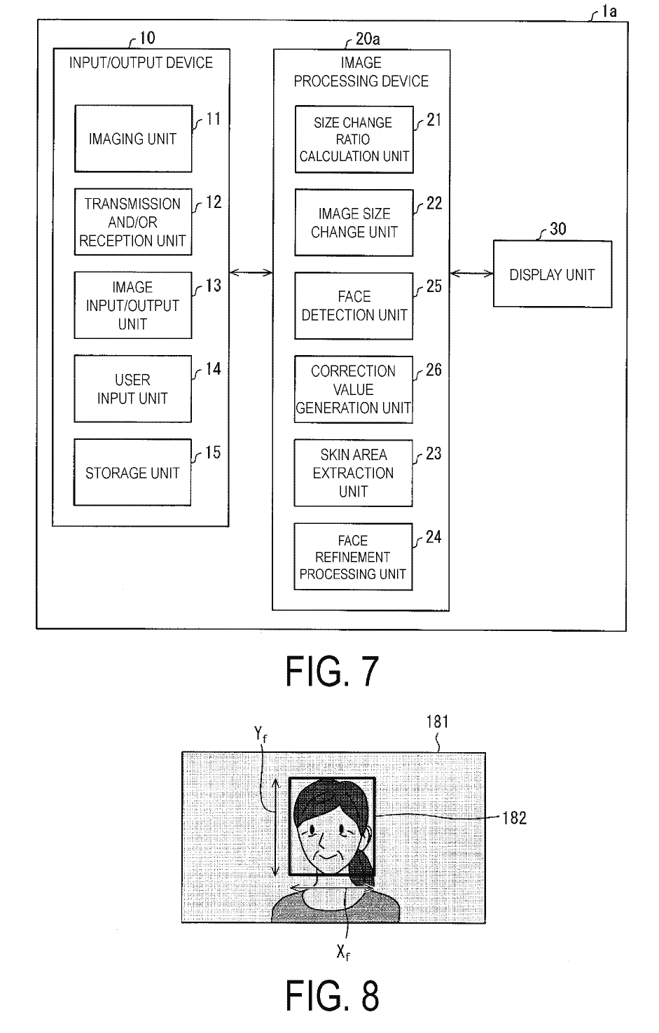

Embodiment 2 according to the present invention is described below based on FIG. 7 to FIG. 10. Each component common to Embodiment 1 described above is designated by the same reference sign, and a detailed description thereof is omitted.

A difference between the present embodiment and Embodiment 1 is in that an image display device 1 a detects a size of the face of the subject included in the input image to correct the degree of the face refinement processing to be performed on the subject according to a result of the detection.

### Constitution of Image Display Device 1a

FIG. 7 is a functional block diagram illustrating a constitution of the image display device la including an image processing device 20a according to

Embodiment 2 of the present invention. As illustrated in FIG. 7, the image display device 1a includes the input/output device 10, the image processing device 20a, and the display unit 30. The input/output device 10 and the display unit 30 are the same as those according to Embodiment 1, a detailed description thereof is omitted.

The image processing device 20a includes the size change ratio calculation unit 21, the image size change unit 22, the skin area extraction unit 23, the face refinement processing unit 24, a face detection unit 25, and a correction value generation unit 26. Specifically, the image processing device 20a is configured to include the face detection unit 25 and the correction value generation unit 26 further added to the image processing device 20 according to Embodiment 1.

The face detection unit 25 detects the size of the face of the subject included in the input image. The correction value generation unit 26 calculates a correction value for correcting the degree of the face refinement processing, based on the detected a size of the face. In the present embodiment, the face refinement processing unit 24 processes the image by the face refinement processing to a degree according to the calculated size change ratio and the correction value. In other words, the face refinement processing unit 24 corrects the degree of the face refinement processing depending on the correction value.

### Details of Face Detection

FIG. 8 is diagram describing details of the face detection in Embodiment 2 of the present invention. FIG. 8 illustrates an image 181 including the subject. The face detection unit 25 detects a size of a face 182 of a subject included in the image 181. The size of the face here refers to the number of horizontal pixels X_{f} and the number of vertical pixels Y_{f} of the face 182 detected from the subject 182. A method for detecting the size of the face 182 from the image 181 includes a method in which the skin color of the subject is detected to identify the face 181. There is also a method in which a discriminant function is statistically obtained in advance, based on learning samples of many face images and images other than the face (non-face images), and the discriminant function is used to detect the size of the face 182 (see, P. Viola and M. Jones, “Rapid object detection using a boosting cascade of simple features”, Proc. IEEE Conf. CVPR, pp. 511-518, 2001).

The face detection unit 25 can also detect multiple faces from the image. In this case, the face detection unit 25 may calculate an average value of sizes of the detected multiple faces, and output the calculated average value as a size of the face for calculating the correction value to the correction value generation unit 26. Alternatively, the size of the largest or smallest face among the sizes of the detected multiple faces may be output as the size of the face for calculating the correction value. Alternatively, the size of the face the closest to the center of the image may be output as the size of the face for calculating the correction value.

In the above example, the face detection unit 25 detects the size of the face of the subject from the input image, but the present invention is not limited thereto. For example, the face detection unit 25 may detect, from the image after its size is changed by the image size change unit 22 (magnified image or reduced image), the size of the face of the subject (the size of the face after magnification or the size of the face after reduction). Particularly, in a case that the size of the face is detected from the reduced image, a processing amount required for the detection can be reduced, so this is preferable.

### Correction Value Generation Processing

The correction value generation unit 26 generates the correction value for correcting the degree of the face refinement processing, based on the detected size of the face. The larger the face of the subject included in the image, the more conspicuous the skin discoloration and wrinkles in the skin area. Then, in a case that the size of the face is larger, the correction value generation unit 26 generates the correction value for further heightening the degree of the face refinement processing. On the other hand, the smaller the face of the subject included in the image, the less conspicuous the skin discoloration and wrinkles in the skin area of the subject. Then, in a case that the size of the face is smaller, the correction value generation unit 26 generates the correction value for further lowering the degree of the face refinement processing.

In the present embodiment, the correction value generation unit 26 uses Equation (5) below to generate the correction value for correcting the degree of the face refinement processing.

$$\begin{matrix}[ Equation 5 ] & \\ H = \frac{F - {F}_{min}}{{F}_{max} - {F}_{min}} & ( 5 )\end{matrix}$$

In Equation (5), H represents the correction value, F represents the size of the face, Fₘₐₓ represents the size of the largest face to be detected, and Fₘᵢₙ represents the size of the smallest face to be detected. In generating the correction value, the total number of pixels to constitute the detected face may be used as the size of the face, besides the number of horizontal pixels or the number of vertical pixels described above. By use of Equation (5), H to be generated is 1 in a case that the size of the detected face F is equal to the maximum value Fₘₐₓ, and H to be generated is 0 in a case that the size of the detected face F is equal to the minimum value Fₘᵢₙ.

### Processing for Changing Degree of Face Refinement Processing

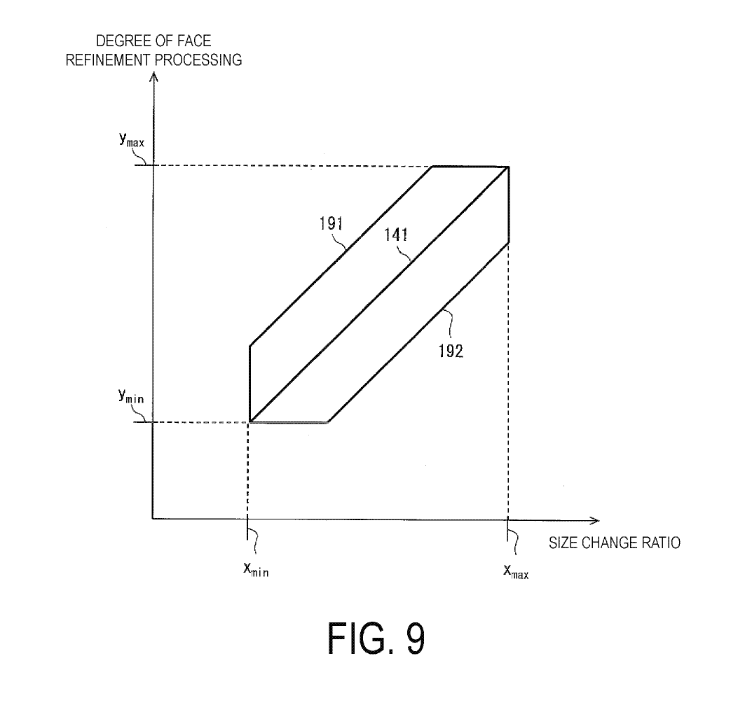

FIG. 9 is a diagram illustrating a relationship between the size change ratio and the degree of face refinement processing in Embodiment 2 of the present invention. In FIG. 9, a component common to FIG. 4 is designated by the same reference sign, and a detailed description thereof is omitted. FIG. 9 illustrates the relationship between the size change ratio, the degree of the face refinement processing, and the correction value.

In a case that the calculated correction value is larger than a threshold (that is, the size of the face is larger than a reference value), the face refinement processing unit 24 uses the correction value to correct the degree of the face refinement processing determined from the straight line 141 in such a way that the relationship between the size change ratio and the degree of the face refinement processing is represented by a function 191 in FIG. 9. This is the correction for further heightening the degree of the face refinement processing because the function 191 is larger in the degree of the face refinement processing than the straight line 141 with respect to the same size change ratio. Specifically, this is the correction to add the correction value to the degree of the face refinement processing determined from the straight line 141.

On the other hand, in a case that the calculated correction value is smaller than the threshold (that is, the size of the face is smaller than the reference value), the face refinement processing unit 24 uses the correction value to correct the degree of the face refinement processing determined from the straight line 141 in such a way that the relationship between the size change ratio and the degree of the face refinement processing is represented by a function 192 in FIG. 9. This is the correction for further lowering the degree of the thee refinement processing because the function 192 is smaller in the degree of the face refinement processing than the straight line 141 with respect to the same size change ratio. Specifically, this is the correction to subtract the correction value from the degree of the face refinement processing determined from the straight line 141.

In a case that the degree of the thee refinement processing after the correction exceeds the maximum value Yₘₐₓ or falls below the minimum value Yₘᵢₙ as a result of correcting the degree of the face refinement processing, the degree of the face refinement processing after the correction may be made to match with the maximum value Yₘₐₓ or the minimum value Yₘᵢₙ. This can prevent generation of an image of strong uncomfortable feeling because of too strong degree of the face refinement processing, or generation of an image hard for the user to perceive the effect of the face refinement processing because of too weak degree of the face refinement processing, and as a result, an image processed by the face refinement processing to more proper degree is generated, so this is preferable.

As described above, the image processing device 20 according to the present embodiment changes the degree of the face refinement processing, based on also the correction value depending on the size of the face, in addition to the size change ratio of the image. In other words, the skin area is processed by the face refinement processing to a degree depending on both the size change ratio and the correction value. As a result, in a case that the face appears large in the image, the degree of the face refinement processing is further heightened, whereas in a case that the face appears small in the image, the degree of the face refinement processing is further lowered. Accordingly, in either case, the image is obtained which is processed by the more preferable face refinement processing, so this is preferable.

### General Processing Flow

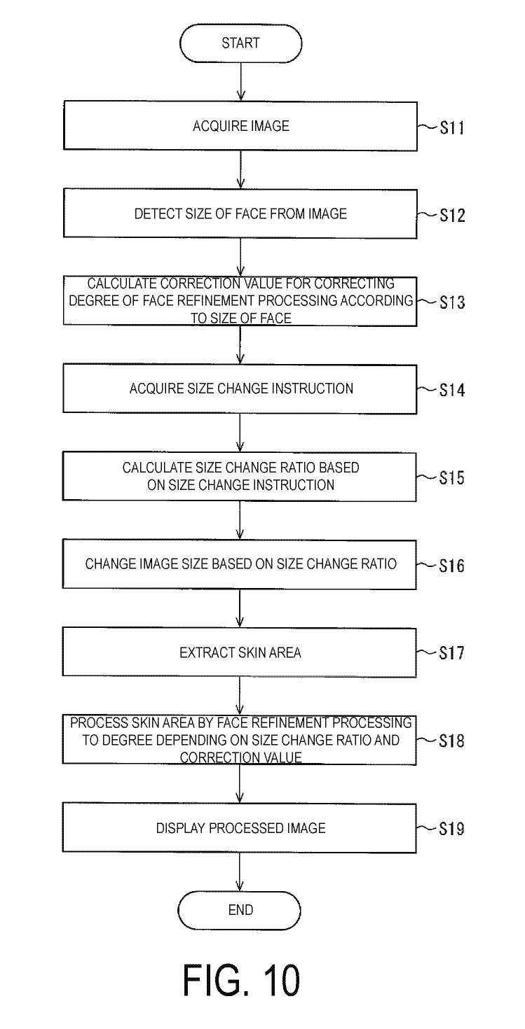

FIG. 10 is a flowchart illustrating a flow of an image processing method performed by the image display device la according to Embodiment 2 of the present invention. As illustrated in FIG. 10, once the processing starts, the image processing device 20a first acquires an image to be displayed from any component in the input/output device 10 (the imaging unit 11, the transmission and/or reception unit 12, or the like) (S11). Next, the face detection unit 25 detects the size of the face of the subject from the input image (S12). Next, the correction value generation unit 26 generates the correction value for correcting the degree of the face refinement processing, based on the calculated size of the face (S13).

Next, the user input unit 14 acquires the size change instruction on the image, input by the user, and outputs the size change instruction to the image processing device 20a (S14). At this time, in a case that no size change instruction is input, the size change ratio may be automatically calculated, similar to Embodiment 1 of the present invention. The size change ratio calculation unit 21 calculates the size change ratio of the image, based on input size change instruction (S15). Next, the image size change unit 22 changes the size of the input image according to the calculated size change ratio (S16). As a result, the image is magnified or reduced.

Next, the skin area extraction unit 23 extracts the skin area in the subject included in the input image (S17). Next, the face refinement processing unit 24 processes the skin area by the face refinement processing to a degree depending on the size change ratio and the correction value (S18). The face refinement processing unit 24 outputs the image after the face refinement processing to the display unit 30, and the display unit 30 displays the input image (S19). This ends the processing illustrated in FIG. 10.

According to the image display device 1 including the image processing device 20 according to Embodiment 1 of the present invention describe above, the image can be generated which is processed by the proper face refinement processing depending on both the size change ratio and the size of the face.

In the present embodiment, the face detection unit 25 detects the size of one face, and then, the correction value generation unit 26 generates one correction value, but the present invention is not limited thereto. For example, the face detection unit 25 may detect the sizes of multiple faces, and then, the correction value may generate multiple correction values, based on the sizes of the respective faces to be output to the face refinement processing unit 24. This can change for each face the correction value for the degree of the face refinement processing applied to the skin area. As a result, even in a case that the face appearing large and the face appearing small are in the image in a mixed manner, the skin area of each face can be processed by the face refinement processing to a proper degree depending on the size of each face,

### Example Implemented by Software

The functional blocks in the image processing device 20 illustrated in FIG. 1 and image processing device 20a illustrated in FIG. 7 may be implemented by a logic circuit (hardware) formed on an integrated circuit (IC chip) or the like, or by software using a Central Processing Unit (CPU).

In the latter case, the image processing device 20 includes the CPU performing instructions of a program that is the software implementing the functions, a storage device such as a Read Only Memory (ROM) in which the program and various data are stored to be readable by a computer (or CPU) or a Hard Disk (HDD) (each of these is referred to as a “recording medium”), a Random Access Memory (RAM) in which the program is deployed, and the like. The computer (or CPU) reads from the recording medium and performs the program to achieve the object of the present invention. The software here may be a part of a so-called Operating System (OS). The “computer” here includes the hardware such as a peripheral device.

Examples of the recording medium to be used includes “non-transitory tangible medium”, for example, various portable record media such as a tape, a disk (flexible disk, magnetic optical disk, CD-ROM, etc.), a card, a semiconductor memory, a programmable logic circuit, and a HDD, or a built-in recording medium. The program may be supplied via any transmission medium capable of transmitting the program (communication network, broadcast wave, etc.) to the computer. The present invention may be implemented also in a form of data signal embedded in a carrier wave in which the program is embodied by electronic transmission.

Moreover, a “computer-readable recording medium” includes a medium that retains the program for a short period of time, such as a communication line that is used to transmit the program over a network such as the Internet or over a communication line such as a telephone line. Further, the “computer-readable recording medium” also includes a medium that retains, in that case, the program for a fixed period of time, such as a volatile memory provided in computers which function as a server and a client sending and receiving the program.

The image processing device 20 (20a) according to the embodiments described above may be partially or entirely implemented as an LSI, which is a typical integrated circuit. The functional blocks in the image processing device may be individually implemented as chips, or may be partially or entirely implemented into a chip. The integrated circuit is not limited to the LSI, and may be implemented by a dedicated circuit or a general-purpose processor. In a case that with advances in semiconductor technology, a circuit integration technology with which an LSI is replaced appears after filing the present application, it is also possible to use a new integrated circuit based on the technology to implement the image processing device 20 (20a).

### Supplement

An image processing device according to Aspect 1 of the present invention includes a size change ratio calculation unit configured to calculate a size change ratio of an image including a subject, an image size change unit configured to change a size of at least a part of the image based on the size change ratio, a skin area extraction unit configured to extract a skin area of the subject included in the at least a part of the image after changing the size of the image, and a face refinement processing unit configured to process the skin area by face refinement processing to a degree depending on the size change ratio.

According to the above constitution, the skin area is processed by the face refinement processing to a proper degree depending on the size change ratio of the image. For example, the face refinement processing is performed to a higher degree in a case that the size change ratio is larger, so that an effect can be enhanced of removing pores of skin and the like in the skin area after magnification. This can prevent an appearance of the subject included in the image after its size changing from being spoiled.

In the image processing device according to Aspect 2 of the present invention, in Aspect 1, in a case that the at least a part of the image is reduced, the face refinement processing unit is configured to process the skin area by the face refinement processing to a lower degree.

According to the above constitution, the reduced skin area can be processed by the face refinement processing to a proper degree.

In the image processing device according Aspect 3 of the present invention, in Aspect 1 or 2, in a case that the at least a part of the image is magnified, the face refinement processing unit is configured to process the skin area by the face refinement processing to a higher degree.

According to the above constitution, the magnified skin area can be processed by the face refinement processing to a proper degree.

In the image processing device according to Aspect 4 of the present invention, in any one of Aspects 1 to 3, the face refinement processing unit is configured to process the skin area by at least one of smoothing processing, skin color correction processing, and shade superposition processing as the face refinement processing.

According to the above constitution, the skin area can be preferably processed by the face refinement processing.

In the image processing device according to Aspect 5 of the present invention, in Aspect 4, the face refinement processing unit is first configured to process the skin area by the smoothing processing and the skin color correction processing to remove an original shade in the skin area, and next, process the skin area by the shade superposition processing to superpose a new shade on the skin area.

According to the above constitution, a proper new shade can be superposed on the skin area, so the stereoscopic effect on the skin area can be improved.

The image processing device according to Aspect 6 of the present invention, in any one of Aspects 1 to 5, further includes a face detection unit configured to detect a size of a face of the subject, and a correction value generation unit configured to generate a correction value for correcting a degree of the face refinement processing based on the size of the face, in which the face refinement processing unit is configured to process the skin area by the face refinement processing to a degree depending on both the size change ratio and the correction value.

According to the above constitution, proper face refinement processing proper depending on the size of the face of the subject in addition to the size change ratio is performed on the correction value.

In the image processing device according to Aspect 7 of the present invention, in Aspect 6, the correction value generation unit is configured to generate the correction value for further heightening the degree of the face refinement processing as the size of the face is larger.

According to the above constitution, the effect of removing the pores of skin and the like can be enhanced on the skin area in which the pores of skin and the like are more conspicuous.

In the image processing device according to Aspect 8 of the present invention, in Aspect 6 or 7, the correction value generation unit is configured to generate the correction value for further lowering the degree of the face refinement processing as the size of the face is smaller.

According to the above constitution, the skin area in which the pores of skin and the like are inconspicuous can be prevented from being processed by the face refinement processing to an unnecessarily high degree.

An image processing method according to Aspect 9 of the present invention includes a size change ratio calculation process of calculating a size change ratio of an image including a subject, an image size change process of changing a size of at least a part of the image based on the size change ratio, a skin area extraction process of extracting a skin area of the subject included in the at least a part of the image after changing the size of the image, and a face refinement processing process of processing the skin area by face refinement processing to a degree depending on the size change ratio.

According to the above constitution, an effect is exerted similarly to the image processing device according to Aspect 1 described above.

The image processing device according to the aspects of the present invention may be implemented by a computer. In this case, a scope of an aspect of the present invention also includes a control program of the image processing device and a computer-readable recording medium recording the control program, the control program causing the computer to operate as the units included in the image processing device to implement the image processing device in the computer.

### Supplemental Note

The present invention is not limited to each of the above-described embodiments. It is possible to make various modifications within the scope of the claims. An embodiment obtained by appropriately combining technical elements disclosed in different embodiments falls also within the technical scope of an aspect of the present invention. Further, combining technical elements disclosed in the respective embodiments can form a new technical feature.

For example, the constituent elements according to the embodiments may be adequately selected as needed.

In FIG. 1 and FIG. 7 for the above embodiments, control lines and information lines between the components are illustrated which are only those considered to be needed for description. In other words, all of the control lines and information lines required in a product realized by embodying the present invention are not necessarily illustrated. All components in FIG. 1 and FIG. 7 may be connected with each other.

### CROSS-REFERENCE TO RELATED APPLICATION

The present application claims priority based on Japanese Patent Application No. 2015-166908 filed on Aug. 26, 2015, all of the contents of which are incorporated herein by reference.

### REFERENCE SIGNS LIST

1, 1a Image display device
10 Input/output device
11 Imaging unit
12 Transmission and/or reception unit
13 Image input/output unit
14 User input unit
15 Storage unit
20, 20a Image processing device
21 Size change ratio calculation unit
22 Image size change unit
23 Skin area extraction unit
24 Face refinement processing unit
30 Display unit

1.-5. (canceled)

6. An image processing device comprising:
image size change circuitry configured to change a size of at least a part of an image including a subject;
skin area extraction circuitry configured to extract a skin area of the subject included in the at least a part of the image whose size has been changed by the image size change circuitry;
face detection circuitry configured to detect a size of a face of the subject; and
face refinement processing circuitry configured to process the skin area by face refinement processing to a degree depending on both of (i) a size change ratio of the size of the at least a part of the image and (ii) the size of the face.

7. The image processing device according to claim 6, wherein
in a case that the at least a part of the image is reduced in size, the face refinement processing circuitry processes the skin area by the face refinement processing to a lower degree.

8. The image processing device according to claim 6, wherein
in a case that the at least a part of the image is magnified in size, the face refinement processing circuitry processes the skin area by the face refinement processing to a higher degree.

9. The image processing device according to claim 6, wherein
the face refinement processing circuitry increases a degree of the face refinement processing as the size of the face increases.

10. The image processing device according to claim 6, wherein
the face refinement processing circuitry performs, on the skin area, a smoothing processing, a skin color correction processing, and a shade superposition processing in this order, as the face refinement processing.

11. A computer-readable non-transitory recording medium in which a program causing a computer to function as the image processing device according to claim 6 is recorded.
